(19) United States
(12) Patent Application Publication
(10) Pub. No.: US 2007/0295925 A1
(43) Pub. Date: Dec. 27, 2007

(54) Fluid control valve

(76) Inventors: Bernhard Spiegl, Vienna (AT); Manfred Kurz, Altenstadt (DE); Georg Strobel, Obertraubling (DE)

Correspondence Address: DYKEMA GOSSETT PLLC, FRANKLIN SQUARE, THIRD FLOOR WEST, 1300 I STREET, NW, WASHINGTON, DC, 20005, US

(21) Appl. No.: 11/812,680

(22) Filed: Jun. 20, 2007

(30) Foreign Application Priority Data
Jun. 22, 2006 (AU) A 1055/2006

(51) Int. Cl. F16K 31/02

(52) U.S. Cl. 251/129.07

(57) ABSTRACT

A fluid control valve that includes an electromagnetic actuator in the form of a pot-shaped magnet (7) as well as an armature plate (6) controllable by the actuator, said armature plate including a closing member (5) cooperating with a valve seat (17, 18). The armature plate (6) is compensated in pressure through a connecting passage (19) within the closing member (5) whereby the pressurized coil chamber (20) of the actuator is pressure sealed to the outside with its cover 13 which is made in one piece with the magnet housing (8) to be able to employ the valve also in the high-pressure range.

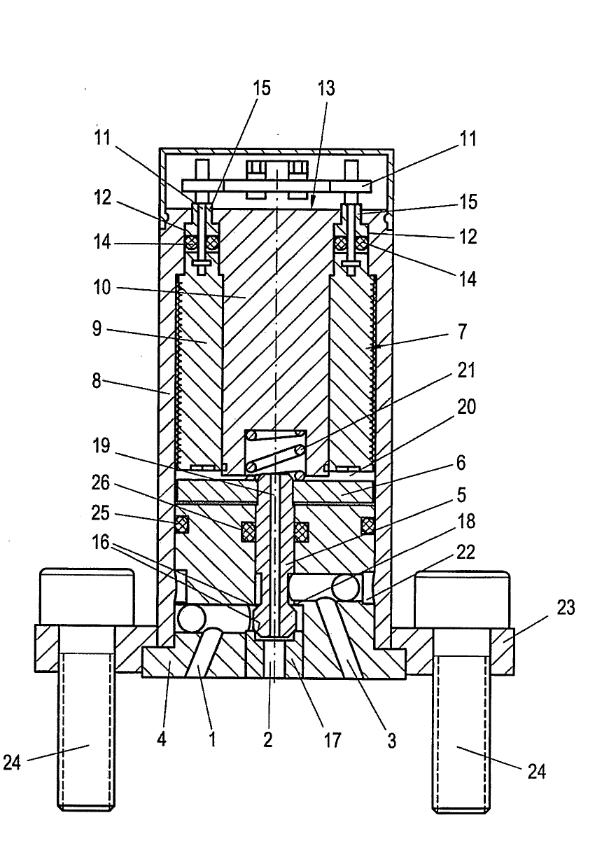

### BACKGROUND OF THE INVENTION

1. Field of the Invention

The invention relates to a fluid control valve that includes an electromagnetic actuator in the form of a pot-shaped magnet as well as an armature plate controllable by the actuator whereby the armature plate is provided with a closing member cooperating with a valve seat and whereby the armature plate is compensated in pressure through a connecting passage within the closing member and whereby the pressurized coil chamber of the actuator is pressure sealed to the outside.

2. The Prior Art

DE 44 19 446 A1, DE 103 40 941 A1 and U.S. Pat. No. 6,182,943 B3 disclose valves that include an electromagnetic actuator in the form of a pot-shaped magnet and an armature plate controllable by the actuator whereby the armature plate is provided with a closing member cooperating with a valve seat. These valves are employed for pneumatic and hydraulic operations and make possible the goal of using high magnetic forces to switch the closing member by having an actuator of small dimensions whereby magnetic valves can be offered which are optimized in terms of structural size and output.

It is of disadvantage in case of the above-mentioned known embodiments of valves in that they are very limited for high-pressure employment, particularly for high-pressure hydraulics, since the relatively large closing member, which is biased by pressure for switching, would require very high magnetic forces to actuate the valve and this could only be realized with a detrimental enlargement of dimensions in construction, weight increase and power consumption (e.g. the armature plate is directly connected to the closing member as disclosed in the aforementioned DE 103 40 941 A1).

An additional valve of the aforementioned type is disclosed in DE 199 08 875 A1, for example, which is suitable as a fuel injection valve for combustion engines only to control relatively low fluid pressures.

It is the object of the present invention to improve the valve of the aforementioned type in such a manner that the cited disadvantages of the known arrangements are avoided and whereby it will become possible to employ valves of this type in the high-pressure range, particularly in high-pressure hydraulics.

### SUMMARY OF THE INVENTION

This object is achieved in the present invention with a valve of the aforementioned type in that the magnet housing surrounding the coil chamber is closed tightly with a cover, which is made in one piece with the housing and is disposed at the opposite side of the armature plate, having only a pressure seal at the through-opening(s) for the electrical connections of the coil of the pot-shaped magnet. Full efficiency can be reached thereby in a simple manner with very low magnetic forces while keeping the advantages of an actuator in form of a pot-shaped magnet since essentially equal pressure conditions exist at both sides of the closing member including the armature plate.

The pressurized coil chamber of the actuator is sealed in a very simple and effective manner in that the magnet housing is closed with a cover, which is made in one piece with said housing, whose through-openings for the electric connection must be very small, of course, wherein effective forces at high pressure are very low and can be easily controlled with simple seals—each or all through-openings in the cover are provided with an annular seal, preferably an O-ring, to directly seal connections that are insulated against the cover by means of an insulator.

Aside of the above-mentioned design, the through-openings for the electrical connections can be disposed at the sides without any disadvantages and they can be sealed correspondingly.

In an additional preferred embodiment of the invention it is proposed that the pole body carrying the coil of the pot-magnet is forced into a center receiving part in the cover in axial direction which makes possible in a simple manner the adjustable compensation for manufacturing and installation tolerances during the forced fitting. In addition, the pole body can be designed to be a single piece together with the cover housing or it can be even a single piece together with the cover and the magnet housing, which offers a more cost-effective production of the part.

According to an additional preferred embodiment of the invention it is proposed that the closing member is forced into a center opening of the armature plate in axial direction to further simplify the adjustment of the valve or the compensation for manufacturing and installation tolerances. Both measures can be used either alone or together, if necessary.

The invention is described in more detail in the following with the aid of the attached drawing.

### BRIEF DESCRIPTION OF THE DRAWING

The drawing schematically shows an axial section through a fluid control valve according to a preferred embodiment of the invention.

### DETAILED DESCRIPTION OF THE PREFERRED EMBODIMENT

The valve of the invention illustrated schematically in an axial sectional view is designed as a 3/2-port directional control seat valve and it serves to control the incoming or outgoing flow of fluid passing through the connections 1, 2 and 3. A closing member 5 is axially movable in the valve housing 4 for this purpose whereby said closing member can be actuated by means of a pressed-on armature plate 6. The armature plate 6 is a part of a pot-magnet 7 which carries a coil 9 on a pole body 10 within a magnet housing 8. The coil 9 makes contact with the outside through electrical connections 11 whereby the through-openings 12 in the cover 13 are provided with electrically insulating connections consisting of an O-ring 14 for direct sealing and by means of an insulator 15 insulating against the cover 13 whereby said cover is designed as a single piece together with the magnet housing 8.

The closing member 5 is provided here with conical sealing surfaces 16 which cooperate on one side with an inserted valve seat 17 and on the other side with a valve seat 18, which is the housing side. It can be seen from the illustration that only a very small valve stroke is required for the move from the contact area on one of the valve seats to the contact area on the other valve seat, which leads to a very small movement of the armature plate 6 in axial direction of the closing member 5. The gap between the armature plate 6 and the lower face of the pole body 10 must be of such dimension, in all cases, that this stroke can occur without hindrances from the contact area on the sealing surfaces 16 of the closing member 5 to both valve seats 17, 18. The connection 1 is selectively connected thereby to the connection 2 or 3 depending on the position of the closing member 5.

The armature plate 5 or the closing member 5 is pressure compensated through a connecting passage in the closing member 5 whereby the coil chamber 20 is pressurized. This coil chamber 20 is pressure sealed at the connections to the outside through the O-rings 14. Full efficiency can be reached thereby with very low magnetic forces even at high switching pressures, as it occurs in high-pressure hydraulics, for example, which makes possible having actuators of small construction or having generally small valves.

Only for the sake of completeness there is reference made to the coil spring 21 which is inserted into a lower machined recess in the pole body 10 holding the armature plate 6 or the closing member 5 in a non-flowing condition in the illustrated lower switching position of the valve. The magnet housing 8 can be fixed to the valve housing 4 through forcing it at least partially into a surrounding groove 22 whereby said magnet housing 8 is subsequently fastened to a component (not further illustrated) together with the valve housing by means of a flange 23 and a screw 24 inserted therein, and whereby said component is provided with control openings communicating with the connections 1, 2 and 3. An additional O-ring seal 25 is provided to make a seal between the valve housing and the magnet housing—sealing of the closing member 5 in the valve housing is accomplished by means of an annular seal 26.

Aside of the illustrated one-piece construction of the pole body 10 together with the cover 13 or the magnet housing 8, the pole body 10 could be forced in a simple conceivable manner into a center opening of the cover 13 by being axially adjustable, which simplifies the compensation for installation and manufacturing tolerances or the adjustment of the stroke geometry. The closing member 5 is forced here into a center opening of the armature plate 6 by being adjustable in axial direction, which offers also a simple adjustment possibility during manufacturing and installation to ensure the required freedom of stroke.

We claim:

1. A fluid control valve comprising an electromagnetic actuator in form of a pot-shaped magnet (7) as well as an armature plate (6) controllable by the actuator whereby said armature plate is provided with a closing member (5) cooperating with a valve seat (17, 18) and whereby the armature plate (6) is compensated in pressure through a connecting passage (19) within the closing member (5) and whereby the pressurized coil chamber (20) of the actuator is pressure sealed to the outside, wherein the magnet housing (8) surrounding the coil chamber (20) is closed tightly with a cover (13), which is made in one piece with the housing and is disposed at the opposite side of the armature plate (6), having only a pressure seal at the through-opening(s) (12) for the electrical connections (11) of the coil (9) of the pot-shaped magnet (7).

2. A valve according to claim 1, wherein each or all through-openings (12) in the cover (13) are provided with an annular seal to directly seal electric connections (11) that are insulated against the cover (13) by means of an insulator (15).

3. A valve according to claim 2, wherein the annular seal is an O-ring.

4. A valve according to claim 1, wherein the pole body (10) carrying the coil (9) of the pot-magnet (7) is forced into a center receiving part in the cover (13) in axial direction.

5. A valve according to claim 1, wherein the closing member (5) is forced into a center opening of the armature plate (6) in axial direction.
